(19) United States
(12) Patent Application Publication
(10) Pub. No.: US 2025/0257565 A1
(43) Pub. Date: Aug. 14, 2025

(54) Methods and Systems of Shear Wall Construction

(71) Applicant: Board of Trustees of Western Michigan University, Kalamazoo, MI (US)

(72) Inventors: Brian Montgomery, Kalamazoo, MI (US); Bilal Alhawamdeh, Kalamazoo, MI (US); Ondrej Pekarovic, Kalamazoo, MI (US)

(21) Appl. No.: 19/050,040

(22) Filed: Feb. 10, 2025

Related U.S. Application Data
(60) Provisional application No. 63/551,764, filed on Feb. 9, 2024.

(51) Int. Cl. E04B 2/70; C09J 5/00; C09J 163/00; C09J 175/04; C09J 183/08

(52) U.S. Cl. CPC E04B 2/707; C09J 5/00; C09J 163/00; C09J 175/04; C09J 183/08; C09J 2400/306

(57) ABSTRACT

Embodiments of the present disclosure may comprise a system for minimizing damage from lateral forces in shear walls, the system including: at least two precut studs, wherein the precut studs are of dimensions 2×6 or greater, and wherein the at least two precut studs are affixed to at least one top plate and one bottom plate with fasteners; and sheathing affixed to at least one side of each of the at least two pre-cut studs with fasteners and with a high-elongation adhesive. Aspects may include methods of assembling lateral-force resistant shear walls, including: affixing at least two precut studs, wherein said at least two precut studs are at 2×6 or greater in dimension, to at least one top plate and one bottom plate with fasteners; and affixing sheathing to at least one side of each of the at least two pre-cut studs with fasteners and with a high-elongation adhesive.

### CROSS-REFERENCE TO RELATED APPLICATIONS

The present application claims the benefit of U.S. Provisional No. 63/551,764, filed Feb. 9, 2024, the contents of which are incorporated herein in their entirety.

### TECHNICAL FIELD

Embodiments and aspects of the present disclosure relates to systems and methods for increasing lateral load resistance in light frame wood shear wall design and construction with reduced cost in labor and materials.

### BACKGROUND OF THE INVENTION

Modern elastomeric adhesives can potentially transform the realm of light-frame wood (LFW) construction, offering a cost-effective solution to increase strength, stiffness, and energy dissipation under lateral loads induced by earthquakes and wind. LFW shear walls are integral to lateral force resistance, providing a primary source of stiffness and strength to the structure by transferring loads to the foundation. The current model of shear walls is that they dissipate high lateral loading energies through plastic deformation of the sheathing frame connections, resulting in nail yielding, nail withdrawal, and sheathing edge tearing, preventing larger-scale structural damage.

Investigators have found that conventional adhesives, including water-based, solvent-based, and polyurethane-based (PU) adhesives, can significantly improve shear wall strength and stiffness. However, concerns about volatile emissions, lack of durability, and brittleness limit their application in LFW structures, and they are currently not allowed in most seismic-focused construction codes. On the other hand, silyl-modified polyether (SMP) adhesives are gaining interest in construction for their moisture-curing, isocyanate-free, UV-stable, chemical-resistant, and high flexibility properties.

Embodiments and aspects of the present disclosure relate to the use of SMP adhesives and wall construction techniques to improve safety while unexpectedly reducing cost in materials and labor at the same time in walls designed to reduce high lateral load stresses.

Applications may include increasing safety, reducing overall cost of construction, and may have special application in areas subject to seismic activity and high winds.

### SUMMARY OF THE INVENTION

Embodiments of the present disclosure may include a system for minimizing damage from lateral forces in shear walls, the system include: at least two precut studs, wherein said precut studs are of dimensions 2×6 or greater, and wherein said at least two precut studs are affixed to at least one top plate and one bottom plate with fasteners; and sheathing affixed to at least one side of each of the at least two pre-cut studs with fasteners and with a high-elongation adhesive.

In other embodiments, the high-elongation adhesive is applied continuously along the length of said at least one side of each of the at least two pre-cut studs. In others, the high-elongation adhesive is applied in a continuous layer less than 5 mm thick. In others, the continuous layer is about 3 mm thick.

In other embodiments, the high-elongation adhesive includes a comprising silyl modified polymer. In yet others, the silyl-modified polymer includes silyl-modified polyethers and/or silyl modified polyurethanes. In others, the high-elongation adhesive includes a silyl modified polyether. In yet others, the high-elongation adhesive comprises an amino silane.

In other embodiments, the at least two precut studs are spaced 24 inches on center. In others, the system can withstand lateral forces up to at least 12 kip without failure. In yet others, the at least two pre-cut studs are 2×6 in dimension.

Aspects of the present disclosure may include a method of assembling lateral-force resistant shear walls, the method including: affixing at least two precut studs, wherein said at least two precut studs are at 2×6 or greater in dimension, to at least one top plate and one bottom plate with fasteners; and affixing sheathing to at least one side of each of the at least two pre-cut studs with fasteners and with a high-elongation adhesive.

In others, the high-elongation adhesive is applied continuously along the length of said at least one side of each of the at least two pre-cut studs. In yet others, the high-elongation adhesive is applied in a continuous layer less than 5 mm thick.

In other aspects, the high-elongation adhesive includes a comprising silyl modified polymer. In others, the silyl-modified polymer includes silyl-modified polyethers and/or silyl modified polyurethanes. In others, the high-elongation adhesive includes an amino silane.

In other aspects, the at least two precut studs are spaced 24 inches on center. In others, the shear wall can withstand lateral forces up to at least 12 kip without failure. In others, the at least two pre-cut studs are 2×6 in dimension.

### BRIEF DESCRIPTION OF THE DRAWINGS

FIG. 1 depicts a schematic of the test specimen from a 2×4 shear wall of the prior art;

FIG. 2 depicts test setup details from a 2×4 shear wall of the prior art;

FIG. 3 depicts lateral load and displacement relationships of monotonic and cyclic tests for the N configuration of the prior art;

FIG. 4 depicts lateral load and displacement relationships of monotonic and cyclic tests for the NA configuration of the prior art;

FIG. 5 depicts lateral load and displacement relationships of monotonic and cyclic tests for the N configuration of the prior art;

FIG. 6 is a photograph of a 2×6 shear wall configuration of an example embodiment of the present disclosure;

FIG. 7 is a graph of the displacement monotonic curve of 2×6 shear wall configure of the present disclosure with and without adhesive;

FIG. 8 is a graph comparison specimens with and without adhesive in terms of ductility, energy and stiffness;

FIG. 9 is a photograph of a failure mode of the reference specimen without adhesive;

FIG. 10 is a photograph of a failure more of an example embodiment of the present invention with adhesive;

FIG. 11 is a photograph of a failure mode of the reference specimen without adhesive, focusing on the junction of the wall with the floor plate;

FIG. 12 is a photograph of a failure more of an example embodiment of the present invention with adhesive focusing on the junction of the wall with the floor plate.

### DETAILED DESCRIPTION OF THE INVENTION

The seismic and other loads (such as high winds) performance of wood buildings is intimately related to energy dissipation properties of the connections between structural elements. On its own, wood has poor dissipative capacity due to its brittle behavior unless effectively strengthened. The structural behavior and capacity of light-frame shear walls (LFSW) primarily depend on sheathing-to-framing connections. Holding down and shear transfer are the two limiting criteria of importance. Mechanical fasteners such as nails can sufficiently dissipate energy in part via their ductility, due to their yielding and limited crushing in the wood. However, they also exhibit significant pinching, strength degradation, and softening in high lateral load events.

Constructing walls in high seismicity regions requires increased and more detailed building specifications than in normal construction (e.g., more detailed prescriptions for nail size, spacing, and sheathing thickness). However, high materials cost and high-level technical experience create barriers to adopting such solutions. There remains a significant need to develop new and innovative construction materials to overcome the limitations of efficiency and cost in current building practices and codes in seismic (and other lateral load) event-prone areas.

Construction adhesives have long been used in combination with nails in the construction of LFW floor systems. American Plywood Association recommends this common practice to mitigate floor vibration, increase floor stiffness for gravity loading, and reduce the potential for squeaking. The use of adhesives in addition or jointly with fasteners such as nails has been investigated to stiffen wood framing to aid in resistance to mechanical stresses such as high winds. However, the use of adhesives for LFSWs is banned in seismic areas due to the limited ductility of most construction adhesives and associated brittle failure modes. However, moderate to high-elongation elastomeric adhesives combined with nails between sheathing-to-framing connections on the seismic performance of light-frame shear walls (LFSWs) may provide a shear-resistant, cost-effective, easily installed, and environmentally friendly alternative solution using moderate to high-elongation elastomeric adhesives applied to sheathing-to-framing connections of LFSWs.

Elastomeric adhesives are synthetic polymer-based. Of particular interest is silyl-terminated polyether adhesive, as it is thermosetting, moisture curing, and solvent-free. Several researchers have investigated standard construction adhesives, noting that may effectively provide increased strength and stiffness to LFSWs. Oliva (1990) tested a series of wood-framed walls that used nails and construction adhesive to attach the gypsum sheathing to studs and determined that adhesive increased the wall strength by 160% and the stiffness by 230% relative to walls with nails alone. Filiatrault and Foschi (1991) tested several LFSWs with plywood sheathing attached using a synthetic elastomer wood adhesive and concluded that adding the adhesive increased initial wall racking stiffness by 65% and the strength by 45-70%. Dolan and White (1992) concluded that special attention is needed when designing anchorages and tie-downs of walls with sheathing connected using adhesives, however, due to the high shear strength provided by the adhesive connections.

However, as noted above, for shear wall sheathing attachment, the Special Design Provisions for Wind and Seismic (SDPWS) guidelines explicitly stipulate only limited uses of adhesives for wind and seismic design in Seismic Design Categories A, B, and C, with response modification factor (R=1.5) and overstrength factor (Ωₒ=2.5). This restriction was issued due to the limited ductility and brittle failure modes of rigid adhesive shear walls as reported by Filiatrault and Foschi (1991).

The present disclosure provides systems and methods for shear wall construction in seismic and other load areas of concern (such as e.g., wind load) using elastomeric adhesives.

### Example 1

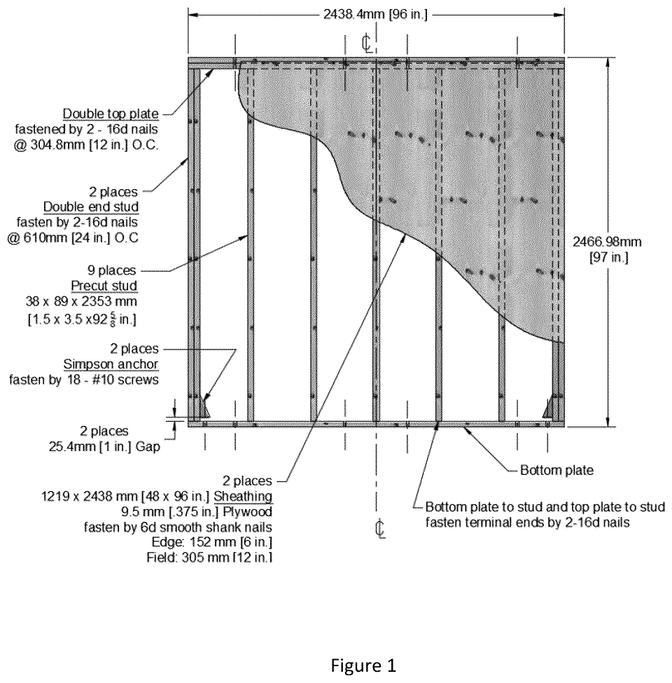

Bilhawamdeh and Shao (2022) investigated the potential structural and economic benefits of adopting a continuous adhesive bond between the framing and sheathing to provide the primary load transfer mechanism in LFSWs in standard 2×4 construction. Three configurations of LFSWs (see Table 1) were designed, fabricated, and tested. Monotonic and reverse cyclic loadings were laterally applied to the specimens along the in-plane direction. FIG. 1 depicts details of the test specimen and test setup. Two specimens were built for each configuration and each loading test, resulting in six specimens in total. Douglas-fir was selected for the framing and ⅜″ plywood for the sheathing.

Referring to FIG. 1, the overall dimensions of the reference section were 2438.4 mm (96 in) horizontally, and 2466.98 mm (97 in) vertically. Wall contained a double top plate, nailed together by 2 16d nails per nailing site at 304.8 mm (12 in) spacing on center, with two double end studs nailed together with two nails per nailing site 610 mm (24 in) spacing. End studs and interior studs (9×) were 38×89 mm dimensions (1.5×3.5 in, i.e. “2×4”) precut to a length of 2353 mm (92⅝ in). Simpson holdown anchors were fastened by 18 #10 screws at the inside bottom end of the double end studs, with a 25.4 mm (1 in) gap at the bottom. Studs were fastened to the bottom place and top plate with 2 16d nails. The bottom plate was a single 2×4 stud. Sheathing (9.5 mm (0.375 in) thickness, 1219×2438 in (48×96 in)) was installed over the wall in two places with 6d smooth shank nails, with 152 mm (6 in) spacing at the plywood edge and 3056 mm (12 in) spacing in the field.

TABLE 1
Shear wall configurations

| Configuration | |
|---|---|
| index | Sheathing to framing attachment |
| N | Nails only: 6d shank smooth nails |
| NA | Nails plus Adhesive A (300% elongation and 400 psi |
| | shear strength) |
| NB | Nails plus Adhesive B (1000% elongation and 300 psi |
| | shear strength) |

Table 2 shows the composition and mechanical properties of the A and B used in the testing. The adhesive cost in each specimen at the time of experiment was less than 21 US dollars, resulting in a 21% increase in the total material cost.

TABLE 2
Mechanical properties of the A and B adhesives

| | Polymer | | Shear | Shear | Curing |
|---|---|---|---|---|---|
| | adhesive | Elongation | Strength | Stiffness | time |
| Adhesive | base | (%) | (psi) | (kips/in) | (days) |
| A | silyl-modified | 991 | 300 | 2.34 | 3 |
| | polyether | | | | |
| B | polyurethane | 70 | 780 | 7.65 | 7 |

For the NA and NB specimens, adhesive thickness of approximately ⅛″ (3 mm) was applied at the contact surface to cover the entire stud width when flattened by the sheathing boards. At this application rate some adhesive oozed out from the sides of the studs upon sheathing attachment, showing a complete bond with the sheathing. Three cartridges of 10.1 oz (300 ml) were used for a shear wall with a total cost of less than $21 for the standard wall unit tested. The monotonic and cyclic tests were performed according to the ASTM E2126-11 and the ASTM E564-06. The CUREE basic loading protocol was chosen as the cyclic loading protocol of applying displacement-controlled loading that involves cycles grouped in phases at incrementally increasing displacement levels (Krawinkler et al., 2001).

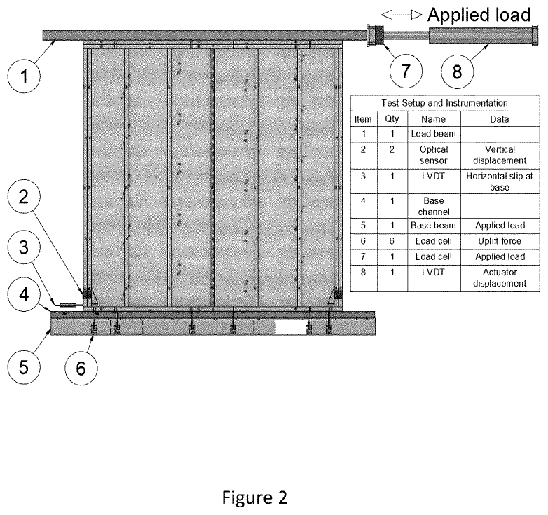

FIG. 2 depicts the testing setup and instrumentation for the wall described above. Load is applied to load beam 1 via load cell 7, with two optical sensors 2 to detect vertical displacement. A linear displacement transducer (LVDT) 3 measures horizontal slip at the base. The wall sits atop a base channel 4 and base beam 5; uplift force load is applied to the latter (and thus the wall) via load cell 7. Movement at the top of the wall can be detected by LVDT 8. The bottom plate is attached to the base beam 5 via regularly spaced bolts.

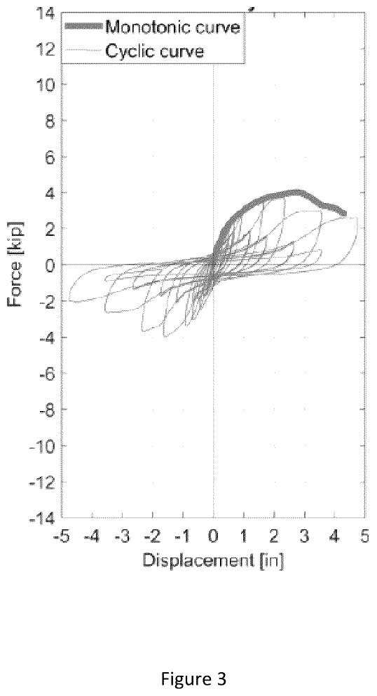

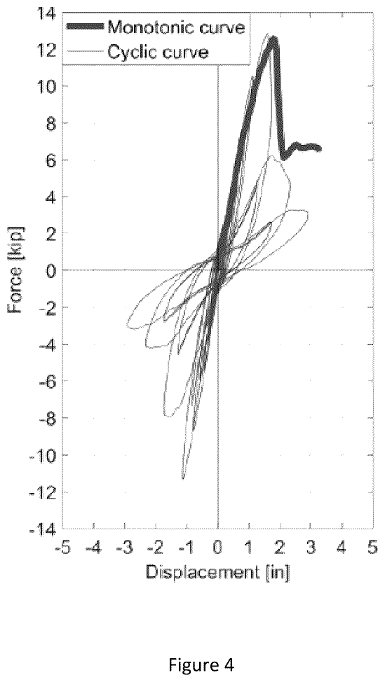

FIGS. 3-5 shows the hysteretic responses of the shear walls under cyclic loading, along with the force-displacement curves under monotonic loading. The monotonic curves are close to the envelopes of the hysteresis loops, showing that monotonic tests results can be used to predict maximum loads and corresponding displacements from the cyclic testing results. As seen in FIG. 3, the nails-only shear wall failed at 4 kip, with a maximum displacement before failure of about 4 inches. In contrast, in FIG. 4, the NA shear wall failed at 12 kip, maintaining a displacement of about 3 inches before failure, i.e., less ductility than with nails only, but much higher stiffness. The NB shear wall had a maximum load of 11 kip, but with ductility more like the N shear wall, with maximum displacement of 4 inches before failing, showing the ability to transfer more load forces without breaking than N or NA.

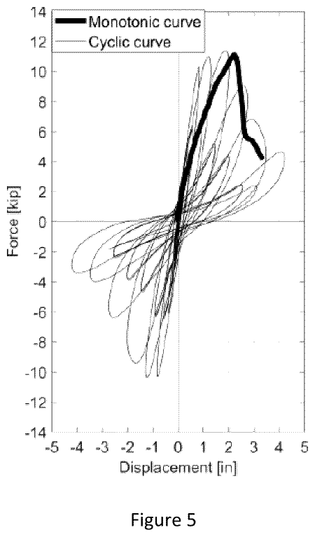

In summary, the N configuration has a higher ductility and lower load capacity and a larger displacement than adhesive walls (see FIG. 3). No significant damage was observed in sheathing panels nor framings. In comparison, adhesive configurations are stiffer with higher load capacity. The NA configuration shows an almost linear force-deformation relationship prior to failure (see FIG. 4). The higher shear strength and lower elongation of adhesive A relative to adhesive B (see Table 2) provide a rigid bond strength that exceeds the wood strength. The NB configuration shows relatively more ductile behavior with a higher level of nonlinearity than NA (see FIG. 5). The desired mechanical properties of adhesive B allowed a higher number of nails to fail without inciting wood failure. It is worth noting that the adhesive shear resistance mechanism eliminated pinching in the hysteresis responses (i.e., hysteretic cycles passing closer to the horizontal axis when the direction of the load is reversed as a result of crack closure and nail slip), leading to more energy dissipation.

Several key parameters and design values were calculated as per ASTM E2126 and building codes (see Table 3). Maximum load (Pₚₑₐₖ), ultimate load (Pᵤₗₜ, last load at 0.8 Pₚₑₐₖ), and the corresponding displacements were determined from the envelope curves obtained by averaging the absolute values of the corresponding positive and the negative envelope points for each cycle, whereas yield and energy dissipation from the equivalent energy elastic-plastic (EEEP) curve (Section 3.2.5 ASTM E2126). The results show that load capacities of NA and NB configurations are significantly increased by approximately 3×, and the initial stiffness by more than 1.5× when compared with the N configuration. Designing a shear wall to the same load and stiffness capacities of adhesive walls requires thicker sheathing ( 19/32″ rather ⅜″), larger nail size (10d rather 6d), and closer spacing (3″ rather 6″). NA configuration slightly increased energy dissipation to the limited plastic deformations, albeit higher loads achieved.

The dominant wood failure in the NA configuration reduced the contribution of nail deformation in increasing the energy dissipation. In contrast, the NB configuration doubled the energy dissipated due to the higher plastic deformations and higher loads prior to failure. The higher elongation capability of the adhesive led to expanding plastic deformations and ensuring a minimal contribution from the nails. R factor is a seismic design factor estimated based on energy dissipation through inelastic behavior. The results of Rₑₓₚ for the NA configuration match well with the design values.

TABLE 3
Monotonic and cyclic characteristic parameters of shear wall configurations

| | | | | | | | | | | | |
|---|---|---|---|---|---|---|---|---|---|---|---|
| | | | | | Stiffness | | | | Rₑₓₚ | | |
| Conf. | Pₚₑₐₖ | P_{yield} | Δ_{yield} | Δᵤₗₜ | @0.4P_{Peak} | Energy | Ductility, D | Ωₑₓₚ | [sqr(2D − | | |
| index | (kips) | (kips) | (in) | (in) | (kips/in) | (kips · in) | [Δᵤₗₜ/Δ_{yield}] | [Pₚₑₐₖ/P_{yield]} | 1) · Ω] | Ω_{design}¹ | R_{design}² |

Monotonic Results

| | | | | | | | | | | | |
|---|---|---|---|---|---|---|---|---|---|---|---|
| N | 4.0 | 3.5 | 0.65 | 3.9 | 5.0 | 13.3 | 6.0 | 1.2 | 4.0 | 3 | 6.5 |
| NA | 12.6 | 11.4 | 1.3 | 2.0 | 8.8 | 14.8 | 1.5 | 1.1 | 1.6 | 2.5 | 5 |
| NB | 11.1 | 9.4 | 1.1 | 2.5 | 8.5 | 18.1 | 2.3 | 1.2 | 2.4 | | |

Cyclic Results

| | | | | | | | | | | | |
|---|---|---|---|---|---|---|---|---|---|---|---|
| N | 3.9 | 3.4 | 0.4 | 3.2 | 8.5 | 10.1 | 7.9 | 1.2 | 4.4 | 3 | 6.5 |
| NA | 12.0 | 10.6 | 0.84 | 1.5 | 12.6 | 11.2 | 1.8 | 1.1 | 1.8 | 2.5 | 1.5 |
| NB | 10.7 | 9.9 | 0.63 | 2.3 | 15.7 | 19.9 | 3.7 | 1.1 | 2.7 | | |

^{1, 2}According to ACSE7-16 (Table 12.2-1) for N conf., and SDPWS (Sec. 4.3.6.3.1) for NA & NB confs.

However, the NB configuration shows a higher value than the design value by 80%, indicating that Adhesive B has an apparent impact on increasing the ductility. The R-factor in the current code provisions needs to be reviewed for the proper adhesive and wood configuration combined with mechanical fasteners.

In summary, monotonic and cyclic tests were conducted on six specimens. Results reveal that adding adhesive increases strength significantly by (170˜200%) and stiffness by (50˜80%) and eliminates pinching and softening effects compared with the nails-only counterparts. Energy dissipation is doubled using high-elongation adhesive (i.e., 1000%), while a slight increase is observed in wall specimen using the moderate-elongation adhesive (i.e., 300%) due to the brittle wood substrates failure. As an indicator of energy dissipation through plastic deformations and ductility, the response modification factor of the high elongation adhesive shows a higher value (2.4˜2.7) than the design value by the building codes (1.5).

### Example 2

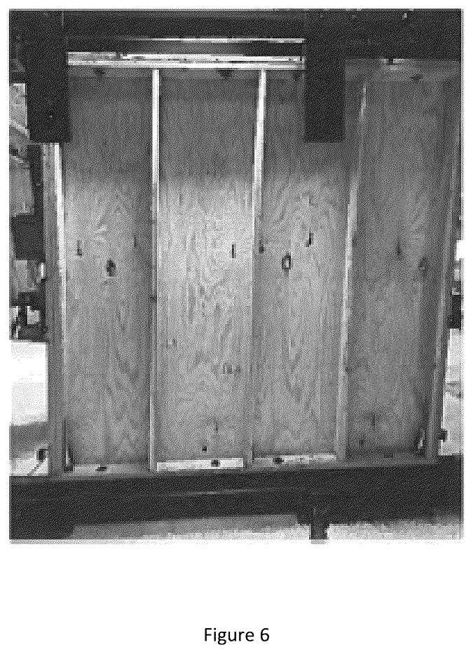

Two 2″×6″ shear walls were tested having a Silyl Terminated Polyether Adhesive (STPA) bead applied to the stud/sheathing interface along with traditional nails. In addition, the additional 2″×6″ structural thickness allows three vertical studs (i.e., on 24 inch centers) versus five in a standard 2″×4″ wall (compare FIGS. 1 and 2), thus decreasing consumable lumber yet increasing volume to accommodate additional insulation. FIG. 6 is a photograph of the 2×6 shear wall construction tested; the test section is the same as in FIG. 1 except for the reduced number of interior studs needed and the additional wall thickness afforded by the 2×6 lumber.

Specimens were tested as in Example 1, with sensors placed as in FIG. 2.

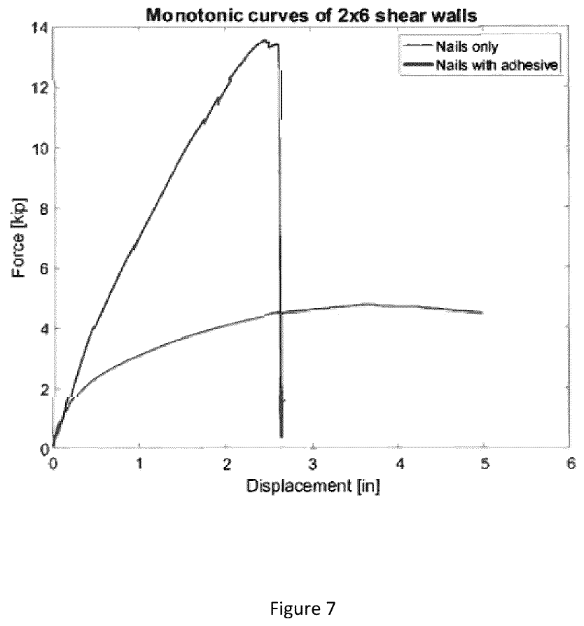

FIG. 7 is a graph of the displacement monotonic curve of 2×6 shear wall configuration of the present disclosure on test specimen walls built with and without adhesive. Similar to Example 1, nails only shear walls showed a maximum of 4 kip force before failure, while adhesive+nails shear walls showed roughly 13 kip before failure, with a displacement great than 2 inches.

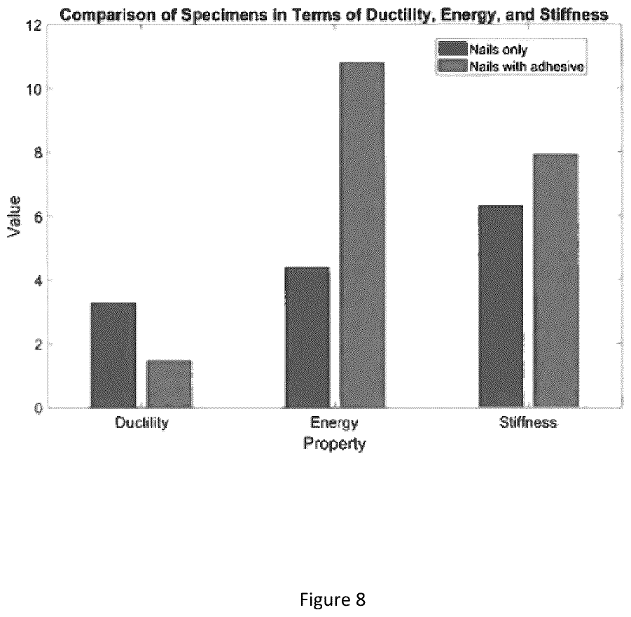

FIG. 8 is a graph comparing specimens with and without adhesive in terms of ductility, energy and stiffness. The force-displacement curves performed under monotonic conditions reveal the STPA wall demonstrated over 3 times the force compared to standard nails and a displacement of 2.5 inches compared to 5 inches for the standard nail-only. This indicates the nail-only wall actually pushes away from the foundation, which is exacerbated by the bending moment of the nails.

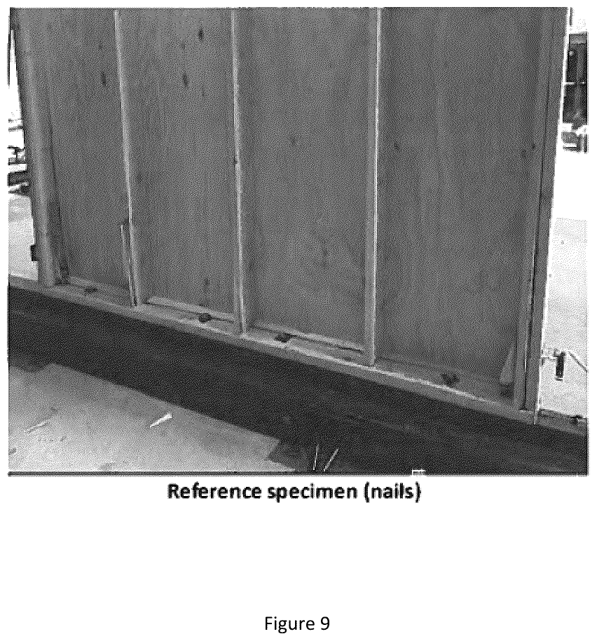

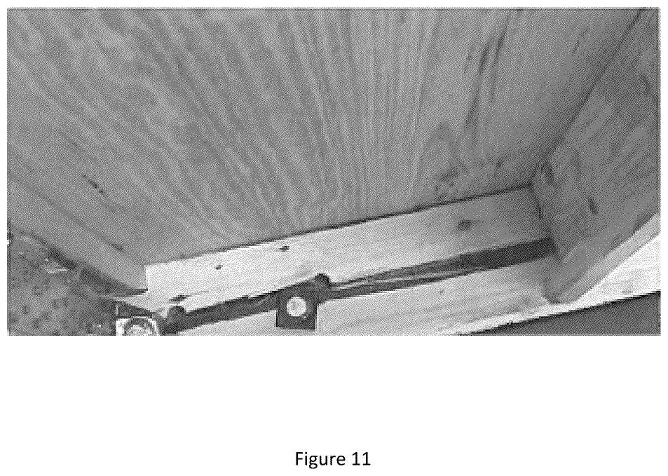

FIG. 9 is a photograph of a failure mode of the reference specimen without adhesive. The photograph shows cracking at the bottom of the studs and cracking of the bottom plate. FIG. 11 is a photograph of a failure mode of the reference specimen without adhesive, focusing on the junction of the wall with the floor plate. Large cracks and displacement are seen in the junction.

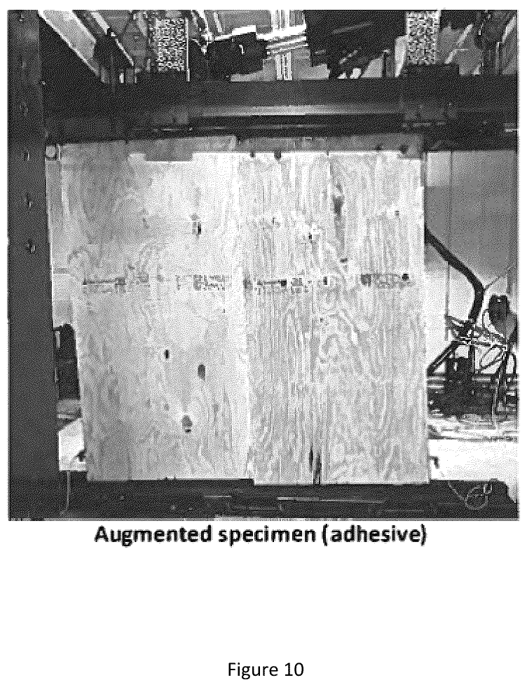

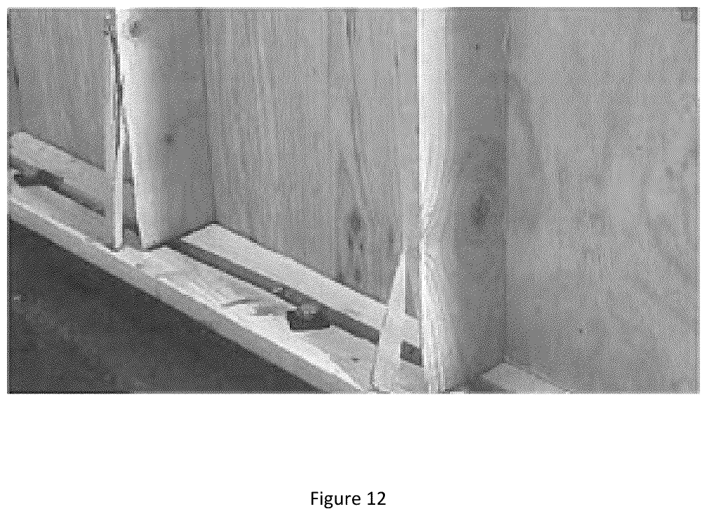

FIG. 10 is a photograph of a failure mode of an example embodiment of the present invention with adhesive, where the nails are allowed to fail. FIG. 12 is a photograph of a failure more of an example embodiment of the present invention with adhesive focusing on the junction of the wall with the floor plate. Similar transference of loads to the floor plate are seen as in the nails only Figures, where the floor plate fails, rather than the bonds at the sheathing, better maintaining overall structural integrity of the main wall assembly and avoiding catastrophic wall failure.

The results demonstrate that aspects and embodiments of a 2″×6″ engineered system offers surprisingly increased strength, resiliency, less consumable lumber and an increase in volume to accommodate additional insulation over the prior art. Elastomeric adhesives thus help give greater strength to wood frame structures without brittleness, allowing lateral forces to dissipate without failure of the sheathing.

Aspects and methods of the present disclosure may use any type of silyl-modified polymer such as silyl modified polyethers and silyl modified polyurethanes, which have the desired properties of solvent-free and isocyanate-free adhesive products, with higher elasticity than acrylic- or polyurethane-based adhesives. Suitable adhesives may contain amino silane.

Suitable fasteners may comprise any allowed by local code, such as nails, screws and the like known to those of skill in the art. An advantage of nails is ease of cost and assembly (usually nails are quicker to manually or mechanically drive into lumber) as well as greater ductility (ability to deflect under stresses such as lateral load stress without breaking or pulling from wood once seated) than screws in many applications.

Sheathing materials may comprise any commonly used, such as plywood, OSB and/or synthetic materials with large enough dimensions to span two or more studs, and of appropriate strength and thickness to resist lateral shear forces (i.e., racking, breaking, or displacement of the studs under lateral forces). In many applications 4×8 sheathing is used, but other longer and wider, and/or shorter/narrower dimensions may be used in certain applications and to conform with building code or specific conditions unique to installation.

1. A system for minimizing damage from lateral forces in shear walls, the system comprising:
at least two precut studs, wherein said precut studs are of dimensions 2×6 or greater, and wherein
said at least two precut studs are affixed to at least one top plate and one bottom plate with fasteners; and
sheathing affixed to at least one side of each of the at least two pre-cut studs with fasteners and with a high-elongation adhesive.

2. The system of claim 1, wherein the high-elongation adhesive is applied continuously along the length of said at least one side of each of the at least two pre-cut studs.

3. The system of claim 1, wherein the high-elongation adhesive is applied in a continuous layer less than 5 mm thick.

4. The system of claim 1, wherein the continuous layer is about 3 mm thick.

5. The system of claim 1, wherein the high-elongation adhesive comprises a comprising silyl modified polymer.

6. The system of claim 5 wherein the silyl-modified polymer comprises silyl-modified polyethers and/or silyl modified polyurethanes.

7. The system of claim 6, wherein the high-elongation adhesive comprises a silyl modified polyether.

8. The system of claim 6, wherein the high-elongation adhesive comprises an amino silane.

9. The system of claim 1, wherein the at least two precut studs are spaced 24 inches on center.

10. The system of claim 1, wherein the system can withstand lateral forces up to at least 12 kip without failure.

11. The system of claim 1, wherein the at least two pre-cut studs are 2×6 in dimension.

12. A method of assembling lateral-force resistant shear walls, the method comprising:
affixing at least two precut studs, wherein said at least two precut studs are at 2×6 or greater in dimension, to at least one top plate and one bottom plate with fasteners; and
affixing sheathing to at least one side of each of the at least two pre-cut studs with fasteners and with a high-elongation adhesive.

13. The method of claim 12, wherein the high-elongation adhesive is applied continuously along the length of said at least one side of each of the at least two pre-cut studs.

14. The method of claim 12, wherein the high-elongation adhesive is applied in a continuous layer less than 5 mm thick.

15. The method of claim 12, wherein the high-elongation adhesive comprises a comprising silyl modified polymer.

16. The method of claim 12 wherein the silyl-modified polymer comprises silyl-modified polyethers and/or silyl modified polyurethanes.

17. The method of claim 16, wherein the high-elongation adhesive comprises an amino silane.

18. The method of claim 12, wherein the at least two precut studs are spaced 24 inches on center.

19. The method of claim 12, wherein the system can withstand lateral forces up to at least 12 kip without failure.

20. The method of claim 12, wherein the at least two pre-cut studs are 2×6 in dimension.
